(19) United States
(12) Patent Application Publication
(10) Pub. No.: US 2018/0215633 A1
(43) Pub. Date: Aug. 2, 2018

(54) Device For Disinfecting Liquids

(71) Applicant: Herbert Waldmann GmbH & Co. KG, Villingen-Schwenningen (DE)

(72) Inventors: Linda Laufer, Bad Dürrheim (DE); Daniel Hug, Bad Dürrheim (DE)

(73) Assignee: Herbert Waldmann GmbH & Co. KG, Villingen-Schwenningen (DE)

(21) Appl. No.: 15/748,538

(22) PCT Filed: May 13, 2016
(86) PCT No.: PCT/EP2016/060902

§ 371 Date: Jan. 29, 2018

(30) Foreign Application Priority Data
Jul. 29, 2015 (DE) 10 2015 112 400.9

(51) Int. Cl. C02F 1/30

(52) U.S. Cl. CPC C02F 1/30; C02F 2209/40; C02F 2305/023; C02F 2301/043; C02F 2303/04; C02F 2209/36

(57) ABSTRACT

A device for disinfecting liquids, comprising at least one photosensitizer and at least one bypass which comprises radiation sources and which is arranged such that light emitted from the radiation sources passes through the liquid. The bypass has at least one layer in which the radiation sources are arranged, and the radiation sources emit visible light and a method for disinfecting liquids using a device, wherein the light emitted from the radiation sources excites the at least one photosensitizer from a base state into an excited state, and reactive oxygen species are formed by means of the energy dispensed by the photosensitizer when transitioning from the excited state into an energetically lower state.

The present invention refers to a device for disinfecting liquids according to the preamble of claim 1 and to a method for disinfecting liquids according to the preamble of claim 13.

In industrial installations, contaminants, which facilitate the growth of germs, are formed in process waters, which are often subject to high temperatures. In particular, cooling lubricants, which play a decisive role in industrial production, are subject to intense soiling in machine tools. Oils, fats and other contaminants which come from outside cause the formation of germs, in particular in water-mixed cooling lubricants. If the cooling lubricant is not disinfected, then the pH value falls in the acid range. This not only negatively influences the lubrication properties of cooling lubricants, but also obstructs the hydraulic system of machine tools, and increases the risk of is corrosion and thus the damaging of corresponding machine parts. Moreover, germs involve an increased risk for the health of operators of machine tools. For these reasons the disinfection of liquids is particularly important. Herein and in the following liquids are considered, which contain oxygen, such as water-mixed liquids.

The UV-disinfection of liquids is known. The irradiation by ultraviolet light causes irreparable damages to the genetic material and thus causes the death of germs. The spectrum of this UV radiation is in the short-waved range. In this case a problem is the fact that the UV radiation is absorbed by contaminants in the liquid and is thus consumed. The penetration depth of radiation is thus reduced, whereby the effect of UV radiation is not sufficient for disinfecting great quantities. Moreover, the UV radiation is dangerous for humans, since it has negative effects on skin and eyes.

The use of biocides is also known. Poisonous biocides have a germicidal effect by damaging the cell membrane or by blocking metabolic processes required for life. The considerable disadvantage is however that not only microorganisms, but also cells of higher organisms are attacked, whereby biocides are unhealthy and poisonous.

It is also known to use electrolytic processes and pasteurization for disinfecting liquids.

It is also known that antimicrobial photodynamic systems may eliminate germs in liquids in an environmentally friendly way. In photodynamic systems, photosensitizers are used for generating an antimicrobial effect, Photosensitizers are light-sensitive substances, which are excited by light. The photosensitizer absorbs during the irradiation optical energy and achieves a transformation from a singlet-base state S0 to the energetically higher singlet state S1. By transformation, i.e., by emission of heat or of fluorescent light, this is again brought back into the base state S0. A further possibility consists in the transition of the photosensitizer from the higher singlet state S1 to the triplet state T1. From here on the energy transfer, which is decisive for the photodynamic effect, from the excited triplet state T1 to neighboring oxygen is molecules takes place, whereby the formation of reactive oxygen species, so-called ROS, is caused. The generated ROS cause the direct oxidative damaging and killing of germs. The photodynamic principle is described, for example, in the specialized publication “Photodynamic biofilm inactivation by SAPYR—An exclusive singlet oxygen photosensitizer” by Fabian Cieplik et al., in “Free Radical Biology in Medicine” published by Elsevier. In the article “Licht soil Antibiotika-resistente Keime vernichten” from VDI Nachrichten, Jun. 13, 2014, photodynamic systems are also described.

Another state of the art is disclosed in publication DE 199 37 834 A1.

The object of the invention is to improve a device for disinfection of liquids, of the type considered, and to provide a corresponding method for disinfecting liquids.

The object of the invention is achieved by a device for disinfecting liquids having the characteristics of claim 1 and by a method for disinfecting liquids having the characteristics of claim 13.

Further embodiments and developments of the invention are described in the dependent claims.

The inventive device for disinfecting liquids with at least one photosensitizer and at least one bypass which comprises radiation sources and which is arranged such that light emitted from the radiation sources passes through the liquid is characterized in that the bypass has at least one layer in which the radiation sources are arranged, and the radiation sources emit visible light. The advantage of an arrangement of radiation sources in a layer consists in that by varying the position of the layer, a volumetric flow of liquid through the bypass may be modified. Thus, beside the flow speed the energy density may also be changed. Light in the visible spectral range is healthy and thus of no risk for humans. The light spectrum of the radiation sources preferably lies in the wavelength range between 390 and 420 nm.

is In a development of the invention, a layer, preferably a layer of translucent material, is arranged between the layer, in which the radiation sources are arranged, and the liquid. Due to this layer, the radiation sources are not directly adjacent to the liquid, and thus better protected. Through the light transparency of a translucent layer the radiation intensity within the bypass may be adjusted.

The radiation sources are advantageously positioned at a reflective surface. Due to the reflective surface, a total reflection may be achieved, whereby the radiation intensity within the bypass may be optimally used. The radiation intensity of the radiation sources may also be adapted to the external conditions.

In a preferred embodiment of the invention, the bypass has a cavity crossing the bypass, in which the liquid may be supplied through the bypass. The liquid may pass through the bypass through such a cavity. The bypass may thus be applied to a liquid circuit.

The layer, in which the radiation sources are arranged, and/or the layer, which is positioned between the layer, in which the radiation sources are arranged, and the liquid, is preferably symmetrically arranged around the cavity. With such an arrangement, the liquid may be irradiated from all sides by the emitted light of the radiation sources,

The radiation sources are preferably arranged in the layer at two sides opposite the cavity. In this way the irradiation of liquid in the bypass may be improved.

The radiation sources in the layer are positioned on two sides opposite the cavity with an offset to one another. Due to an offset arrangement of the radiation sources, the number of radiation sources used may be reduced and thus the production costs may be kept to a reduced level.

In a particularly preferred embodiment of the invention, the bypass is connected by means of inlet and outlet points to a liquid circulation. After the liquid has entered the bypass through inlet points, it may return, through the outlet points, into the liquid circulation. The liquid may thus regularly flow through the bypass, so that a continuous disinfection process may take place.

According to a further embodiment of the invention, the device has a control device and/or a pump, by means of which the flow rate of liquid through the bypass may be regulated. The control device may advantageously regulate the volumetric flow of liquid and thus may allow a flow of charges of liquid or optionally a stop. If required, the liquid may be supplied through an additional pump into the bypass.

In a development of the invention, the at least one photosensitizer may be supplied to the liquid, preferably by means of a dosing device, and may be mixed therewith. The concentration of the photosensitizer of liquid may thus be adjusted.

The device advantageously has sensors, by which a concentration of germs and/or of the at least one photosensitizer in the liquid may be measured. The sensors may forward their measurement values to a dosing device, whereby the concentration of photosensitizer may be correspondingly adjusted and regulated, so that an efficient use of the photosensitizer is facilitated.

According to an alternative embodiment of the invention, the at least one photosensitizer is dissolved in a coating, which may be applied on a surface adjacent to the liquid. A surface coating may hinder the deposit of germs and biofilms on surfaces. In this way, the photosensitizer may be provided as a self-disinfecting surface.

Preferably, the outer shape of the bypass is essentially in the form of a cylinder, a prism, a parallelepiped or a similar geometry. The outer shape of the bypass is thus flexible.

The inventive method for disinfecting liquids with a device as the one previously described is characterized in that the light emitted by the radiation sources excites is the at least one photosensitizer from a base state into an excited state and reactive oxygen species are formed by means of the energy dispensed by the photosensitizer when transitioning from the excited state into an energetically lower state. The activated oxygen, which is formed from the water of the liquid, is in direct contact with the germs and may destroy them in an oxidative way. The germs in liquids may thus be deactivated.

The inventive method may be preferably used for disinfecting operating materials, in particular cooling lubricants, and/or soiled water, water in air conditioning and aeration installations, potable water, pluvial water, bathing water and/or water pipes and other surfaces adjacent to a liquid. A wide application range of the method is thus obtained.

The invention is explained in the following by means of the following figures. In particular:

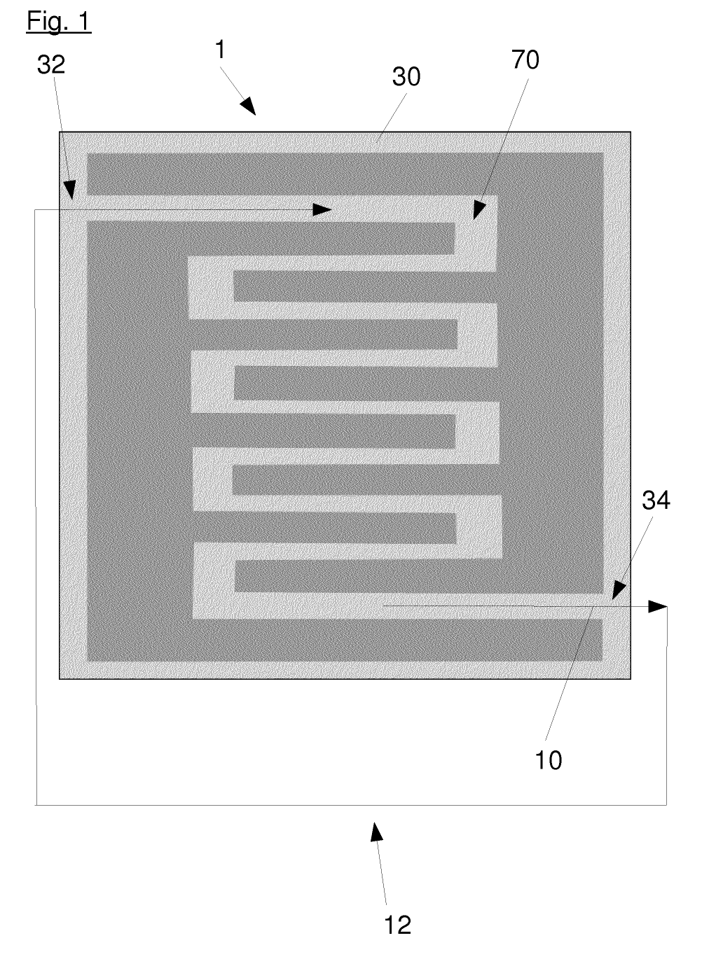

FIG. 1 shows a cross-sectional view of an exemplary embodiment of an inventive device within an exemplary embodiment of a liquid circuit,

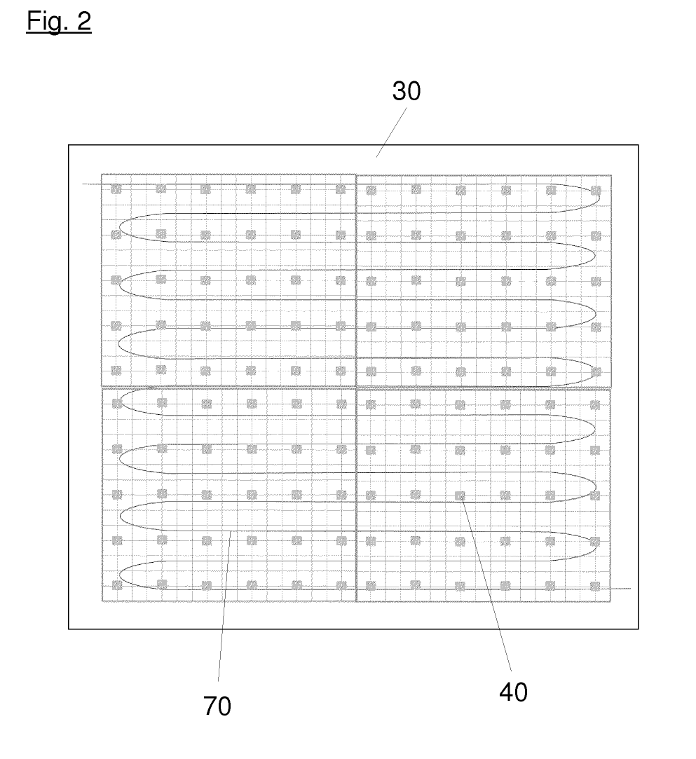

FIG. 2 shows a cross-sectional view of an exemplary embodiment of a bypass,

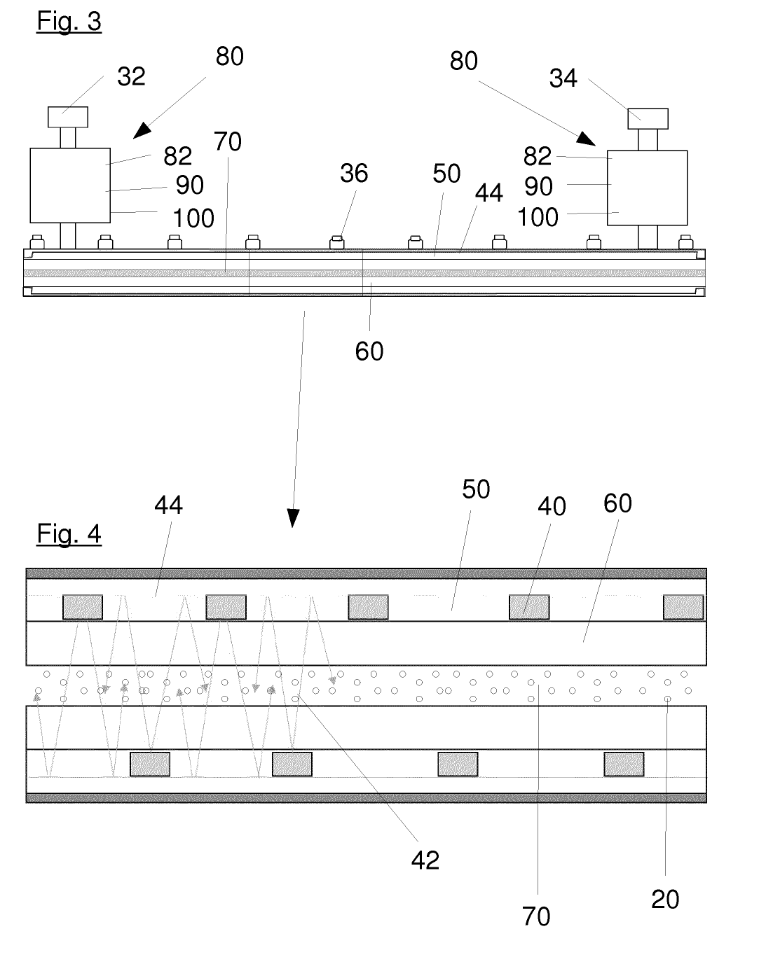

FIG. 3 shows a side view of a further exemplary embodiment of an inventive device, and

FIG. 4 shows a detailed representation of a layer structure of a device according to FIG. 3.

In the figures, same references have the same meaning and define, as far as not otherwise indicated, the same reference parts.

FIG. 1 shows a device 1 for disinfecting a liquid 10 with a bypass 30, wherein the bypass 30 is integrated through an inlet point 32 and an outlet point 34 in a liquid circuit 12. The bypass 30 has a cavity 70, which crosses the bypass 30 and through which the liquid 10 may be supplied. The cavity 70 may extend, for example, comb-like, through the bypass 30.

By arranging the bypass 30 in the liquid circuit 12, a disinfection during passing of liquid 10 through the liquid circuit 12 is possible, so that no stopping takes place.

In FIG. 1, the bypass 30 has a square cross-sectional area. However, the scope of the invention also comprises the fact that the bypass 30 may have a circular or a differently shaped base surface, such as a triangular base surface, or a polygonal base surface..

FIG. 2 shows a cross-sectional view of bypass 30 of FIG. 1. In FIG. 2, the radiation sources 40 which are shown are symmetrically arranged. The light 42 of the radiation sources 40 lies in the visible range of wavelengths between 390 nm and 420 nm. The radiation sources 40 may be light diodes, which are arranged along a flow direction of liquid 10. The radiation intensity of radiation sources 40 may also be adapted to corresponding contingencies. A special arrangement of radiation sources 40 in a layer 50 ensures an optimal use of radiation intensity within the bypass 30.

FIG. 3 shows a side view of a bypass 30 of FIG. 1, The inlet point 32 and the outlet point 34 have a respective control device 80, by which the volumetric flow rate of liquid 10 may be adjusted.

Each control device 80 comprises a pump 82, by means of which, if necessary, the supply of liquid 10 through the bypass 30 is improved. Each control device 80 also comprises a dosing device 90. On each dosing device 90 a sensor 100 is disposed, which measures and monitors respective properties of liquid 10, in particular the concentration of a germ number and of a photosensitizer 20. By forwarding information to the dosing device 20, the concentration of photosensitizer 20 may be correspondingly adjusted and regulated, so that an efficient use of photosensitizer 20 is facilitated.

The photosensitizer 20 is supplied as a concentrate to the liquid 10 and mixed therewith, as also shown in the representation of FIG. 4.

The liquid 10 flows through the cavity 70 of bypass 30. The cavity 70 may be provided as a stainless-steel form, which forms a channel for passage of liquid 10.

The cavity 70 is surrounded by a layer 60, which is preferably made of translucent material. The radiation sources 40 are arranged in a layer 50. In the exemplary embodiment of FIG. 4, the radiation sources 40 in the layer 50 are arranged, in a mutually offset way, on two opposite sides at cavity 70. Surfaces 44 of layer 50 cause a reflection of light 42 into the cavity 70. The surfaces 44 are white surfaces, for example, so that through total reflection an optimal use of radiation intensity within the bypass 30 is achieved.

The bypass 30 has securing means 36, by which the bypass 30 may be secured to a housing frame. The securing means 36 may be screws, for example. Within the scope of the invention the fact is comprised that the fixing means 36 may be an adhesive or another means. Through the securing means 36, by varying a height of cavity and a volume width of a channel, the volumetric flow rate may be modified, adapting it to the volume of liquid 10 (please provide further details). In addition to flow speed, the energy density may thus be also modified.

The photosensitizers 20 may be prepared in such a way that they directly adhere to germs. If the photosensitizers 20, which are present in the liquid 10, are irradiated by visible light 42 from the radiation sources 40, they may absorb the light energy and transfer it to the oxygen contained in the water of the liquid. The activated oxygen, which is directly in contact with germs, destroys the latter in an oxidative way. The germs in the liquids 10 may thus be deactivated.

It lies within the scope of the invention that inventive methods for disinfecting liquids may also be used in process waters inside mechanical systems as well as for manufacturing of products. In the industry, process water is used for manufacturing and processing, for washing and cleaning processes, for varnishing processes, for diluting, for cooling and air conditioning as well as for heating and transport of products. Process water is used, for example, in manufacturing companies, power plants, laundries and washing plants. The process water in industrial plants is often subject to very high temperatures, whereby the growth of germs is greatly facilitated. Moreover, in the industry, processes operate with different materials, which often contact water and thus cause contamination. These contaminants ensure that germ growth is increased.

In particular, cooling lubricants have a decisive role in industrial manufacturing technology, since they only allow for the capacity of modern machine tools to be fully used. Cooling lubricants are required in machining processes as an additive for cooling the tool and the workpiece, as well as for lubricating their contact area and for transporting away the generated chips. In order to disinfect the cooling lubricant in a bypass 30, a bypass 30 is applied to the cooling lubricant circuit of a machine tool. Through inlet points 32 and outlet points 34, the cooling lubricant is supplied from the machine tool into the bypass 30. The germs are deactivated by irradiating the cooling lubricant with visible light 42. After the cooling lubricant has passed through the bypass 30, it returns through outlet points 34 into the cooling lubricant circuit of the machine tool.

The scope of the invention also comprises the use of the method for surface coating. The photosensitizers 20 are dissolved, to this end, into a coating, such as a varnish, which may be applied to the surfaces and within conduits. The radiation source 40, which is arranged in the bypass 30 or on other surfaces, irradiates the surfaces covered by germs, wherein the light spectrum of radiation sources used lies within the visible range of wavelengths between 390 nm and 420 nm. The deposition of germs and biofilms is thus already inhibited. The photosensitizer 20 may thus unfold an antimicrobial effect, or may be provided as a self-disinfecting surface.

Further possible applications of the inventive device and of the inventive method are the disinfection of liquid foods before industrial filling, the disinfection of diesel fuel, the disinfection of water from collecting containers, the disinfection of potable and rainwater, as well as disinfection of dirty and waste water.

The invention requires the interaction of the three components light 42 within the visible spectral range, photosensitizer 20 and oxygen.

The light spectrum of the radiation source 40 used lies within the visible region, so that no harmful UV radiation is emitted. The method is thus friendly to human health and can be safely used by operators.

The photosensitizers 20 are based on modified vitamins dissolved in water, are food-safe, have a neutral color and contain no poisonous chemicals.

Only a small quantity of concentrate is also required for an efficient action in the cooling lubricant. This method may thus facilitate and ensure the environmentally friendly and sustainable use of resources.

The component oxygen is free and always available.

Moreover, the disinfecting process is started only when the photosensitizers 20 are irradiated by light 42. This method may be thus selectively controlled.

The present method for disinfecting liquids is also very efficient and allows for a wide spectrum of action against a plurality of germs, bacteria, viruses and mushrooms.

A further advantage is the flexibility of the bypass 30. The bypass 30 may be applied on any water circuit or any other appliance, so that the bypass 30 may be provided not only for a new use but also for retrofitting applications.

The method also provides two possible applications. The photosensitizers 20 may be mixed with the liquid in the form of a concentrate, or they may be provided in the form of self-disinfecting surfaces.

The application of antimicrobial photodynamic functions to the disinfection of liquids considerably increases the lifetime of liquids. This causes a cost reduction for provision and thus also for disposal.

### LIST OF REFERENCE NUMERALS

1 device

10 liquid

12 liquid circuit

20 photosensitizer

30 bypass

32 inlet point

34 outlet point

36 securing means

40 radiation source

42 light

44 surface

50 layer

60 layer

70 cavity

80 control device

82 pump

90 dosing device

100 sensor

1. A device for disinfecting liquids, comprising:
a photosensitizer, and
a bypass which comprises radiation sources and which is arranged such that light emitted from the radiation sources passes through liquid to be disinfected,
wherein the bypass has a radiation source layer in which the radiation sources are arranged, and the radiation sources emit visible light.

2. The device of claim 1, wherein a translucent layer is arranged between the radiation source layer and the liquid.

3. The device of claim 1, wherein the radiation sources are positioned at a reflecting surface.

4. The device of claim 1, wherein the bypass has a cavity crossing the bypass, in which the liquid may be supplied through the bypass.

5. The device of claim 4, wherein the radiation source layer, the translucent layer, or both, are positioned symmetrically, around the cavity.

6. The device of claim 5, wherein the radiation sources are arranged in the radiation source layer on two sides, which are opposite the cavity.

7. The device of claim 5, wherein the radiation sources are arranged, offset from one another, in the radiation source layer on two sides, which are opposite the cavity.

8. The device of claim 1,
wherein the bypass is connected to a liquid circuit by an inlet and outlet.

9. The device of claim 8, wherein the device has a control device that adjusts a flow rate of the liquid through the bypass.

10. The device of claim 1, further comprising a dosing device that supplies the photosensitizer to the liquid.

11. The device of claim 1, further comprising a sensor for measuring a concentration of germs.

12. The device of claim 1 wherein the photosensitizer is dissolved in a coating of a surface adjacent the liquid.

13. The device of claim 1, wherein the outer shape of the bypass is cylindrical.

14. A method for disinfecting liquids having a device comprising:
providing a device comprising:
a photosensitizer and
a bypass which comprises radiation sources and which is arranged such that light emitted from the radiation sources passes through liquid to be disinfected,
wherein the bypass has a radiation source layer in which the radiation sources are arranged, and the radiation sources emit visible light.
exciting the photosensitizer from a base state into an excited state, and
forming reactive oxygen species by energy dispensed by the photosensitizer when transitioning from an excited state into an energetically lower state.

15. The method of claim 14, further comprising:
disinfecting operating materials selected from the group comprising cooling lubricants, waste water, water in air conditioning and aeration installations, potable water, rainwater, bath water, or water conduits adjacent to the liquid

16. The device of claim 1, further comprising sensor for measuring a concentration of the photosensitizer.

17. A system for disinfecting, comprising:
a bypass comprising:
a cavity through which liquid to be disinfected passes, wherein the liquid contains a photosensitizer;
radiation sources arranged such that light emitted from the radiation sources passes through liquid to be disinfected,
a radiation source layer in which the radiation sources are arranged, wherein the radiation source layer has a reflective surface;
a translucent layer arranged between the radiation source layer and the liquid;
wherein the radiation source layer is formed on opposing sides of the cavity, and the radiation sources are arranged on both sides of cavity and offset from each other.

18. The system for disinfecting, wherein the translucent layer further comprises a surface coating containing the photosensitizer, wherein the photosensitizer is released into the liquid.
